(19) United States
(12) Patent Application Publication
(10) Pub. No.: US 2014/0310633 A1
(43) Pub. Date: Oct. 16, 2014

(54) GEOGRAPHIC INFORMATION SYSTEM (GIS) MAPPING WITH LOGICAL AND PHYSICAL VIEWS OF OIL & GAS PRODUCTION NETWORK EQUIPMENT

(71) Applicant: Schlumberger Technology Corporation, Sugar Land, TX (US)

(72) Inventors: Samuel Glynn McLellan, Temple, TX (US); Bobby Kiehn, Houston, TX (US); Philippe Steinthal, Houston, TX (US)

(73) Assignee: Schlumberger Technology Corporation, Sugar Land, TX (US)

(21) Appl. No.: 14/247,382

(22) Filed: Apr. 8, 2014

Related U.S. Application Data
(60) Provisional application No. 61/811,326, filed on Apr. 12, 2013.

(51) Int. Cl. G06F 3/0484

(52) U.S. Cl. CPC G06F 3/04842
USPC 715/771

(57) ABSTRACT

A method, apparatus, and program product utilize clustering to represent co-located physical components in a production network in a GIS map user interface. A cluster object may be used to represent multiple co-located physical components, and the cluster object may be selectively expanded in place to display a logical view of the multiple co-located physical components in which at least a portion of the equipment objects representing the co-located physical components are offset from one another and interconnected to represent the physical interconnections between the co-located physical components, thereby facilitating selection, visualization and manipulation of the equipment objects representing the co-located physical components.

### CROSS-REFERENCE TO RELATED APPLICATION

This application claims the benefit of U.S. Provisional Application No. 61/811,326 filed on Apr. 12, 2013 by Sam McLellan et al., the entire disclosure of which is incorporated by reference herein in its entirety.

### BACKGROUND

In the oil & gas industry, software applications use tools such as logical network diagrams to design, model, analyze, and optimize any number of hydrocarbon production systems in part or completely, e.g., the flow in a pipelines and facilities surface system, the performance of a system of production and injection wells, or a network of multiple wells or sources. These logical networks may incorporate multiple building blocks of node and connection type objects (e.g., wells, compressors, pump, separators, etc.), which an oil and gas specialist may assemble together in order to logically and visually represent on a two-dimensional canvas the different equipment and their properties that make up a specific, often complex network model, and that may be used to accurately simulate, analyze, understand, and optimize the behavior of the system or the impact of alternative designs.

A Geographic Information System (GIS) map is a two- or three-dimensional representation of a geographic area created with a specialized type of computer mapping software, which employs coordinate systems to provide a visually more realistic view of the oil and gas network of objects against the geographical terrain represented on the map. Oil and gas production equipment such as wells and chokes that make up a complex network may be placed at their appropriate coordinate locations or at the same coordinate locations, and equipment such as pipelines may be used to connect equipment together in a series of curved or straight lines over multiple locations with different elevations and angles—and with automatic access to geographical information such as elevation that a user no longer has to enter individually and manually (a highly time-intensive activity) as part of a large, logical network's information.

It has been found, however, that substantial issues still arise in connection with calculating and displaying a production network of equipment objects on a GIS map in such a way that facilitates user interaction and management of the network, e g., to allow a user to design or alter the network and to see and exercise common or object-specific functionality for any selectable equipment individually or collectively in the network. One particularly problematic area relates to collections of equipment objects that are co-located, i.e., disposed at roughly the same physical location on a map, but that are capable of being connected together in a number of different orders. A location accurate depiction of such equipment objects on a GIS map can make it difficult to select and manipulate individual, closely positioned objects.

Therefore, a need exists in the art for an improved manner of interacting with equipment objects from a production network on a GIS map.

### SUMMARY

The embodiments disclosed herein provide a method, apparatus, and program product that utilize clustering to represent co-located physical components in a production network in a GIS map user interface. A cluster object may be used to represent multiple co-located physical components. The cluster object may be selectively expanded in place to display a logical view of the multiple co-located physical components. The logical view offsets at least a portion of the equipment objects representing the co-located physical components from one another. The logical view may show interconnections to represent the physical interconnections between the co-located physical components, thereby facilitating selection, visualization and manipulation of the equipment objects representing the co-located physical components.

In certain embodiments an oil & gas production network may be visualized by, using at least one processor, causing a display representation of a production network to be displayed in a Geological Information System (GIS) map us interface. The display representation may include a physical view of a plurality of equipment objects representing physical components in the production network. The display representation may position the objects relative to a map according to physical locations of the physical components represented thereby. The display representation may further include a cluster object associated with a plurality of co-located physical components in the production network and positioned relative to the map according to the physical location associated with the plurality of co-located physical components. The cluster object may be expanded in place in the display representation by displaying a logical view of a plurality of clustered equipment objects representing the plurality of co-located physical components. The logical view may display at least one clustered equipment object offset in the map from at least one other clustered equipment object and represents at least one physical interconnection between the plurality of co-located physical components.

Consistent with another aspect of the invention, an apparatus may include at least one processor and program code configured upon execution by processor to visualize an oil & gas production network by causing a display representation of a production network to be displayed in a Geological Information. System (GIS) map user interface. The display representation may include a physical view of a plurality of equipment objects representing physical components in the production network and positioned relative to a map according to physical locations of the physical components they represent. The display representation may further include a cluster object associated with multiple co-located physical components in the production network. The cluster object may be positioned relative to the map according to a physical location associated with the co-located physical components. Expanding the cluster object may display a logical view of the co-located physical components. The logical view may display clustered equipment objects offset in the map from other clustered equipment objects and representing physical interconnection between the co-located physical components.

Consistent with yet another aspect of the invention, a program product may include a computer readable medium and program code configured upon execution by a processor to visualize an oil & gas production network by causing a display representation of a production network to be displayed in a Geological Information System (GIS) map user interface. Tthe display representation may include a physical view of equipment objects representing physical components in the production network and positioned on the map according to physical locations of the associated physical components. The display representation may also include a cluster object associated with multiple co-located physical components in the production network. These cluster objects may be positioned relative to the map at the physical location of the associated co-located physical components. Expanding the cluster object in place in the display representation may display a logical view of the co-located physical components represented by the cluster object. The logical view may display the clustered equipment objects offset in the map from the other clustered equipment objects and represent the physical interconnections between the co-located physical components represented by the cluster object.

In some embodiments expanding the cluster object expandseach cluster object displayed in the display representation when switching from a physical layout view to a logical layout view. In addition, in some embodiments, expanding the cluster object is performed without expanding other cluster objects displayed in the display representation. Some embodiments may synchronize the GIS map user interface with another user interface such that selection of an object on the GIS map user interface or the second user interface causes selection of an object on the other.

In some embodiments, synchronizing the GIS map user interface with the other user interface involves selecting objects associated with the co-located physical components in the second user interface in response to selection of the duster object. Some embodiments also perform operations associated with each of the co-located physical components in response to performing an action directed to the cluster object. In addition, in some embodiments, the display representation of the cluster object includes a numerical indicator of the number of co-located physical components represented by the cluster object, The display representation of the cluster object may include a list of identifiers for the co-located physical components. In some embodiments, the logical view includes a connector object that represents the physical interconnection.

Some embodiments display a preview of the logical view in the physical view, while some embodiments walk the production network to collect cluster masters based on production system rules. Some embodiments walk the production network a second time to attach cluster members to clusters based on connection rules. In some embodiments the cluster object is associated with an auxiliary component that is physically co-located with the co-located physical components in the production network. Expanding the cluster object in place may display the auxiliary object associated with the auxiliary component in the logical view.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a block diagram of an example hardware and software environment for a data processing system in accordance with implementation of various technologies and techniques described herein.

FIGS. 2A-2D illustrate simplified, schematic views of an oilfield having subterranean formations containing reservoirs therein in accordance with implementations of various technologies and techniques described herein.

FIG. 3 illustrates a schematic view, partially in cross section of an oilfield having a plurality of data acquisition tools positioned at various locations along the oilfield for collecting data from the subterranean formations in accordance with implementations of various technologies and techniques described herein.

FIG. 4 illustrates a production system for performing one or more oilfield operations in accordance with implementations of various technologies and techniques described herein.

FIG. 5 is a block diagram illustrating an example implementation of a production system application architecture in accordance with implementations of various technologies and techniques described herein.

FIG. 6 is a display representation of a GIS map with a production network displayed in a logical layout view in accordance with implementations of various technologies and techniques described herein,

FIG. 7 is a display representation of a GIS map with a production network displayed in a physical layout view in accordance with implementations of various technologies and techniques described herein.

FIG. 8 is a flowchart illustrating a sequence of operations to cluster equipment objects in accordance with implementations of various technologies and techniques described herein.

### DETAILED DESCRIPTION

The herein-described embodiments invention provide in part a method, apparatus, and program product for calculating and displaying a complex oil and gas system of equipment objects (for example, surface equipment like wells, compressors, pumps, and such) and connectors between them (for example, pipe or flow lines) in a software application using a GIS (Geographic Information System) map user interface. More specifically, embodiments consistent with the invention address the challenges associated with representing multiple equipment objects that have the same (or closely similar) physical coordinates in the system in order to accurately perform processing (e.g., to perform hydrocarbon flow simulation, analysis, and optimization) but additionally requiring a logical representation in order to facilitate visualization of objects and interaction (e.g., manipulating, editing, or moving) with any individual equipment in the production system, including equipment clustered or aggregated but connected in any of a number of explicit orders at the same physical location.

In the illustrated embodiments, equipment objects representing physical components from the production network that are located at the same or closely proximate physical locations (referred to herein as being “co-located”) are clustered together and represented by a single cluster object on a GIS map user interface, with the interface being selectable between logical and physical views to selectively contract or expand clustered equipment objects in place in a display representation of a production network to facilitate manipulation, visualization and selection of clustered equipment objects.

An equipment object, within the context of the invention, may represent practically any type of equipment or physical component utilized in a production network, e.g., a well, a choke, a compressor, a pump, a source, a sink, a junction, a separator, a multi-phase booster, a heat exchanger, an expander, a multiplier/adder, an injection point, generic equipment, a connector, a flowline, a riser, a valve, a facility, etc. A cluster object, in turn, may represent any collection of co-located physical components located either in the same physical location (i.e., having the same location coordinates) or within a predetermined range of locations associated with a close proximity between objects,. Some objects may not be clusterable in some embodiments, and various representations may be used to represent a cluster object (e.g. a circle with a number indicating the number of objects in a cluster in the illustrated embodiment).

In addition, in some embodiments, a cluster object may also represent additional components, referred to herein as auxiliary components, that are physically co-located with the co-located physical components represented thereby. An auxiliary component may include, for example, a nodal point, a gauge, a report, or other component of a production network that is not necessarily a physical piece of equipment, but that is associated with a particular physical location, e.g., by being associated with a physical component or portion of the production network that is disposed at a particular physical location. An auxiliary object may be used to represent an auxiliary component in a GIS map user interface, and as will become more apparent below, may be clustered along with other auxiliary or equipment objects representing auxiliary or physical components that are physically co-located with one another and thereby represented by a cluster object.

A GIS map user interlace consistent with the invention may include any type of graphical display representation that is capable of representing a collection of physical or auxiliary components and connections therebetween forming a production network on a two-dimensional or three-dimensional map with equipment objects representing such physical components positioned relative to the map according to their respective physical, geographical locations of the physical components, along with any auxiliary objects representing physically co-located auxiliary components. Embodiments of the invention cause a display representation of a production network to be displayed in a GIS map user interface, e.g., by generating data or control signals that either cause a display coupled to a local computer or other electronic device to display a graphical depiction of a map and production network, or that, when communicated over a network, cause a display coupled to a remote computer to display such a graphical depiction.

A GIS map user interface consistent with the invention supports at least two views.

A first view, which in some embodiments may be referred to as a physical layout view or physical view, positions objects representing physical components according to their respective physical locations, and in the illustrated embodiments, represents multiple co-located objects via cluster objects. Any auxiliary objects representing auxiliary components may also be displayed in such a view at appropriate locations, with auxiliary objects physically co-located with any other equipment or auxiliary objects also represented by cluster objects.

A second view, which is some embodiments may be referred to as a logical layout view or logical view, maintains the positions of non-clustered equipment or auxiliary objects, but in lieu of displaying cluster objects, displays separate equipment or auxiliary objects representing the co-located physical or auxiliary components in a logical layout that abandons strict adherence to accurate positioning of at least some of the clustered equipment or auxiliary objects to facilitate selection, visualization or manipulation of the individual objects, e.g., by offsetting at least one of the clustered objects from other clustered objects representing the co-located physical or auxiliary components. For example, in some embodiments the co-located objects may be expanded in place such that the objects are still positioned in generally the same region of the map (e.g., with the collection of objects centered proximate the location of the cluster object) and with additional connections displayed between the objects to represent the physical interconnections of the physical or auxiliary components represented by the objects in the production network.

A GIS map user interface may support views that expand or contract all clustered objects into their respective cluster objects, or may support user interactions that enable individual cluster objects to be expanded or contracted without affecting other cluster objects and clustered objects in the production network.

Other variations and modifications will be apparent to one of ordinary skill in the art.

### Hardware and Software Environment

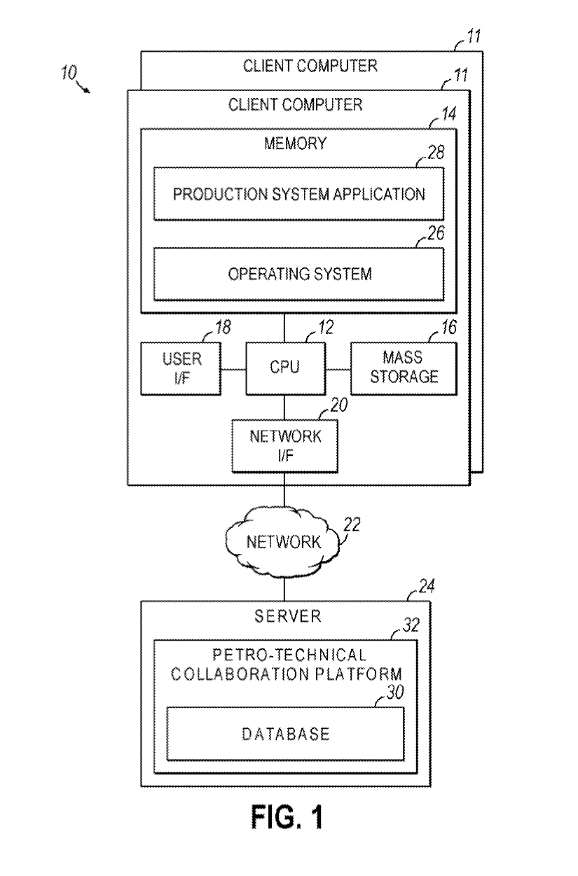

Turning now to the drawings, wherein like numbers denote like parts throughout the several views, FIG. 1 illustrates an example data processing system 10 in which the various technologies and techniques described herein may be implemented. System 10 is illustrated as including one or more computers 11, e.g., client computers, each including a central processing unit 12 including at least one hardware-based microprocessor coupled to a memory 14, which may represent the random access memory (RAM) devices comprising the main storage of a computer 11, as well as any supplemental levels of memory, e.g., cache memories, non-volatile or backup memories (e.g., programmable or flash memories), read-only memories, etc. In addition, memory 14 may be considered to include memory storage physically located elsewhere in a computer 11, e.g., any cache memory in a microprocessor, as well as any storage capacity used as a virtual memory, e.g., as stored on a mass storage device 16 or on another computer coupled to a computer 11.

Each computer 11 also generally receives a number of inputs and outputs for communicating information externally. For interface with a user or operator, a computer 11 generally includes a user interface 18 incorporating one or more user input devices, e.g., a keyboard, a pointing device, a display, a printer, etc. Otherwise, user input may be received, e.g., over a network interface 20 coupled to a network 22, from one or more servers 24. A computer 11 also may be in communication with one or more mass storage devices 16, which may be, for example, internal hard disk storage devices, external hard disk storage devices, storage area network devices, etc.

A computer 11 generally operates under the control of an operating system 26 and executes or otherwise relies upon various computer software applications, components, programs, objects, modules, data structures, etc. For example, a production system application 28 may be used access a database 30 of production equipment data supported in a petro-technical collaboration platform 32. Collaboration platform 32 or database 30 may be implemented using multiple servers 24 in some implementations, and it will be appreciated that each server 24 may incorporate processors, memory, and other hardware components similar to a client computer 11. In addition, other petro-technical applications, e.g., reservoir simulators, production management applications, etc. may be supported or integrated with production system application 28. In some embodiments, a production system application may be resident in a stand-alone computer in which production system data is resident on the same computer as the application. In other embodiments, various client-server, web-based and other distributed architectures may be used, whereby the data or functionality of a production system application is distributed among multiple computers.

In one non-limiting embodiment, for example, production system application may be compatible with the PIPESIM software platform and environment, which is a steady-state, multiphase flow simulator application used for the design and diagnostic analysis of oil and gas production systems, and which is available from Schlumberger Ltd. and its affiliates. It will be appreciated, however, that the techniques discussed herein may be utilized in connection with other production system applications, so the invention is not limited to the particular software platforms and environments discussed herein.

In general, the routines executed to implement the embodiments disclosed herein, whether implemented as part of an operating system or a specific application, component, program, object, module or sequence of instructions, or even a subset thereof, will be referred to herein as “computer program code,” or simply “program code.” Program code generally comprises one or more instructions that are resident at various times in various memory and storage devices in a computer, and that, when read and executed by one or more processors in a computer, cause that computer to execute steps or elements embodying desired functionality. Moreover, while embodiments have and hereinafter will be described in the context of fully functioning computers and computer systems, those skilled in the art will appreciate that the various embodiments are capable of being distributed as a program product in a variety of forms, and that the invention applies equally regardless of the particular type of computer readable media used to actually carry out the distribution.

Such computer readable media may include computer readable storage media and communication media. Computer readable storage media is non-transitory in nature, and may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, DVD, or other optical storage, magnetic cassettes, magnetic tape, magnetic disk storage or other magnetic storage devices, or any other medium that can be used to store the desired information and which can be accessed by computer 10, Communication media may embody computer readable instructions, data structures or other program modules. By way of example, and not limitation, communication media may include wired media such as a wired network or direct-wired connection, and wireless media such as acoustic, RE, infrared and other wireless media. Combinations of any of the above may also be included within the scope of computer readable media.

Various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Furthermore, it will be appreciated by those of ordinary skill in the art having the benefit of the instant disclosure that the various operations described herein that may be performed by any program code, or performed in any routines, workflows, or the like, may be combined, split, reordered, omitted, or supplemented with other techniques known in the art, and therefore, the invention is not limited to the particular sequences of operations described herein.

Those skilled in the art will recognize that the example environment illustrated in FIG. 1 is not intended to limit the invention. Indeed, those skilled in the art will recognize that other alternative hardware or software environments may be used without departing from the scope of the invention.

### Oilfield Operations

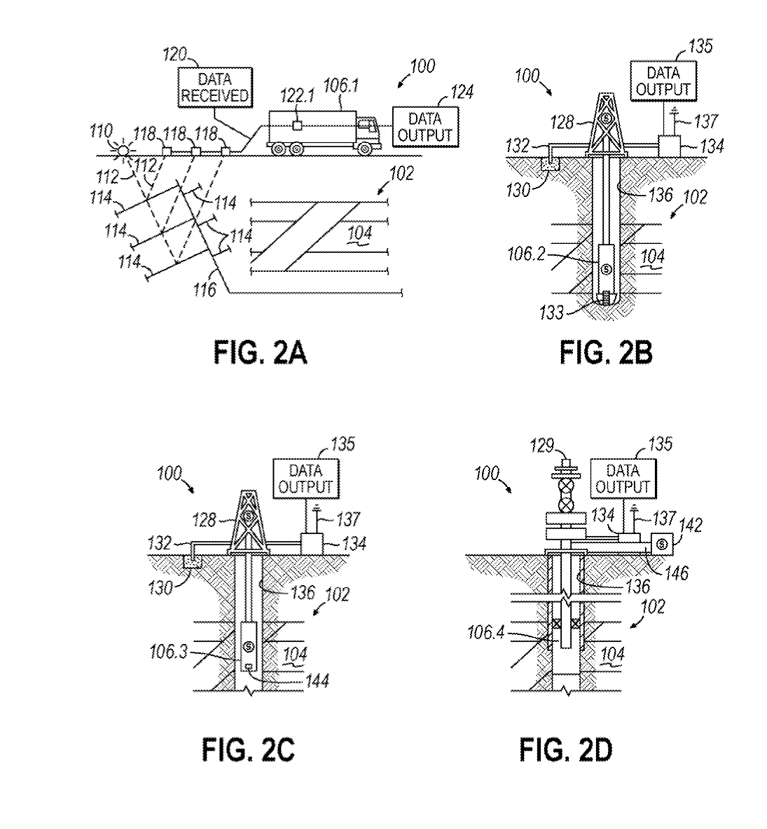

FIGS. 2A-2D illustrate simplified, schematic views of an oilfield 100 having subterranean formation 102 containing reservoir 104 therein in accordance with implementations of various technologies and techniques described herein. FIG. 2A illustrates a survey operation being performed by a survey tool, such as seismic truck 106.1, to measure properties of the subterranean formation. The survey operation is a seismic survey operation for producing sound vibrations. In FIG. 2A, one such sound vibration, sound vibration 112 generated by source 110, reflects off horizons 114 in earth formation 116. A set of sound vibrations is received by sensors, such as geophone-receivers 118, situated on the earth's surface. The data received 120 is provided as input data to a computer 1221 of a seismic truck 106.1, and responsive to the input data, computer 122.1 generates seismic data output 124. This seismic data output may be stored, transmitted or further processed as desired, for example, by data reduction.

FIG. 2B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is generally filtered and returned to the mud pit. A circulating system may be used for storing, controlling, or filtering the flowing drilling muds. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) or at remote locations. Surface unit 134 may be used to communicate with the drilling tools or offsite operations, as well as with other surface or downhole sensors. Surface unit 134 is capable of communicating with the drilling tools to send commands to the drilling tools, and to receive data therefrom.

Surface unit 134 may also collect data generated during the drilling operation and produces data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools or at rig 128 to measure drilling parameters, such as weight on bit, torque on bit, pressures, temperatures, flow rates, compositions, rotary speed, or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Generally, the wellbore is drilled according to a drilling plan that is established prior to drilling. The drilling plan generally sets forth equipment, pressures, trajectories or other parameters that define the drilling process for the wellsite. The drilling operation may then be performed according to the drilling plan. However, as information is gathered, the drilling operation may need to deviate from the drilling plan.

Additionally, as drilling or other operations are performed, the subsurface conditions may change. The earth model may also need adjustment as new information is collected

The data gathered by sensors (S) may be collected by surface unit 134 or other data collection sources for analysis or other processing. The data collected by sensors (S) may be used alone or in combination with other data. The data may be collected in one or more databases or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, or manually by an operator. In some cases, well plans may be adjusted to select optimum operating conditions, or to avoid problems.

FIG. 2C illustrates a wireline operation being performed by wireline tool 106.3 suspended by rig 128 and into wellbore 136 of FIG. 2B. Wireline tool 106.3 is adapted for deployment into wellbore 136 for generating well logs, performing downhole tests or collecting samples. Wireline tool 106.3 may be used to provide another method and apparatus for performing a seismic survey operation. Wireline tool 106.3 may, for example, have an explosive, radioactive, electrical, or acoustic energy source 144 that sends or receives electrical signals to surrounding subterranean formations 102 and fluids therein.

Wireline tool 106.3 may be operatively connected to, for example, geophones 118 and a computer 122.1 of a seismic truck 106.1 of FIG. 2A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition or other parameters of the field operation.

FIG. 20 illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as christmas tree 129, gathering network 146, surface facility 142, or the production facility, to measure fluid parameters, such as fluid composition, flow rates, pressures, temperatures, or other parameters of the production operation.

Production may also include injection wells for added recovery. One or more gathering facilities may be operatively connected to one or more of the wellsites for selectively collecting downhole fluids from the wellsite(s).

While FIGS. 2B-2D illustrate tools used to measure properties of an oilfield, it will be appreciated that the tools may be used in connection with non-oilfield operations, such as gas fields, mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation or its geological formations may be used. Various sensors (S) may be located at various positions along the wellbore or the monitoring tools to collect or monitor the desired data. Other sources of data may also be provided from offsite locations.

The field configurations of FIGS. 2A-2D are intended to provide a brief description of an example of a field usable with oilfield application frameworks. Part, or all, of oilfield 100 may be on land, water, or sea. Also, while a single field measured at a single location is depicted, oilfield applications may be utilized with any combination of one or more oilfields, one or more processing facilities and one or more wellsites.

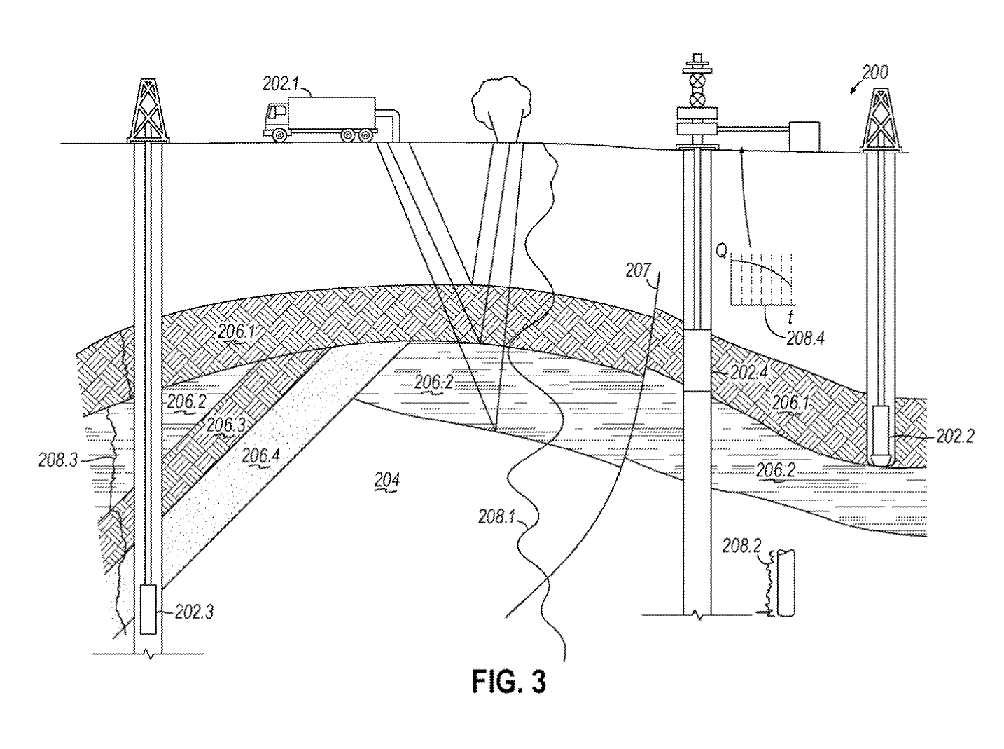

FIG. 3 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 2A-2D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively, however, it should be understood that data plots 208.1-208.3 may also be data plots that are updated in real time. These measurements may be analyzed to better define the properties of the formation(s) or determine the accuracy of the measurements or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that generally provides a resistivity or other measurement of the formation at various depths.

A production decline curve or graph 208.4 is a dynamic data plot of the fluid flow rate over time. The production decline curve generally provides the production rate as a function of time. As the fluid flows through the wellbore, measurements are taken of fluid properties, such as flow rates, pressures, composition, etc.

Other data may also be collected, such as historical data, user inputs, economic information, or other measurement data and other parameters of interest. As described below, the static and dynamic measurements may be analyzed and used to generate models of the subterranean formation to determine characteristics thereof. Similar measurements may also be used to measure changes in formation aspects over time,

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures or formations, sometimes having extreme complexity. In some locations, generally below the water line, fluid may occupy pore spaces of the formations. Each of the measurement devices may be used to measure properties of the formations or its geological features. While each acquisition tool is shown as being in specific locations in oilfield 200, it will be appreciated that one or more types of measurement may be taken at one or more locations across one or more fields or other locations for comparison or analysis.

The data collected from various sources, such as the data acquisition tools of FIG. 3, may then be processed or evaluated. Generally, seismic data displayed in static data plot 208.1 from data acquisition tool 202.1 is used by a geophysicist to determine characteristics of the subterranean formations and features. The core data shown in static plot 208.2 or log data from well log 208.3 are generally used by a geologist to determine various characteristics of the subterranean formation. The production data from graph 208.4 is generally used by the reservoir engineer to determine fluid flow reservoir characteristics. The data analyzed by the geologist, geophysicist and the reservoir engineer may be analyzed using modeling techniques.

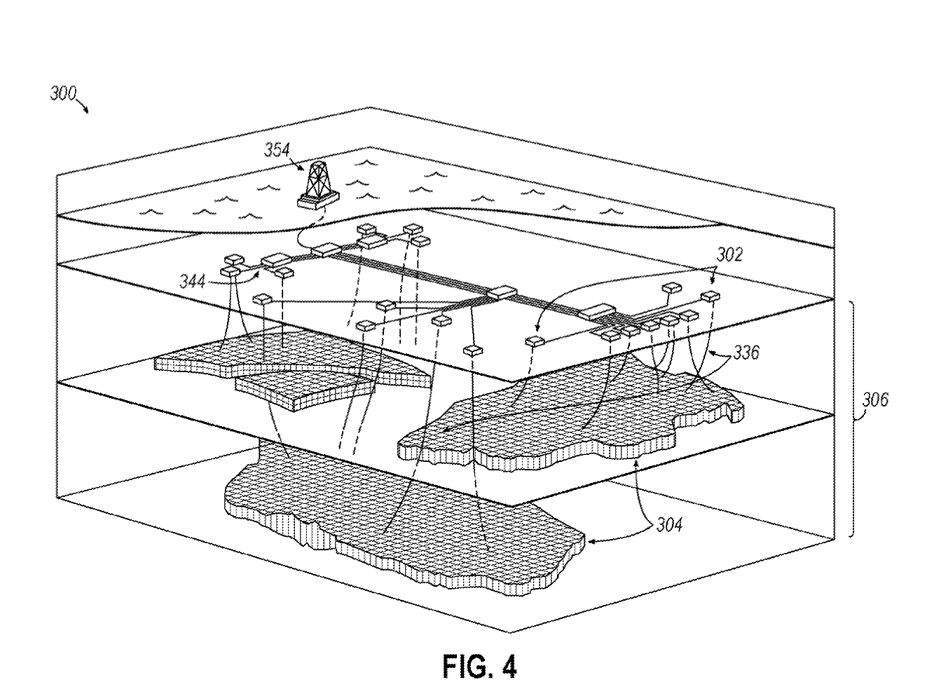

FIG. 4 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 4 is not intended to limit the scope of the oilfield application system. Part or all of the oilfield may be on land or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

### Selection Manipulation and Visualization of Production Equipment in an Oil & Gas Production System

The embodiments discussed herein generally relate to GIS use in an oil and gas industry software application and specifically to an underlying method used to calculate, display and manipulate selectable equipment in an oil and gas production system that may be at the same physical location on a GIS map user interface in the software application. In particular, in the embodiments described herein, clustering is used to support both physical and logical views of a production network on a GIS map, with the physical view locating equipment objects (and in some embodiments auxiliary objects) on a GIS map according to their associated physical locations, and representing those co-located objects by a single cluster object, and the logical view expanding objects that are located at the same or closely proximate physical locations “in place” to facilitate user selection, visualization and manipulation of such objects.

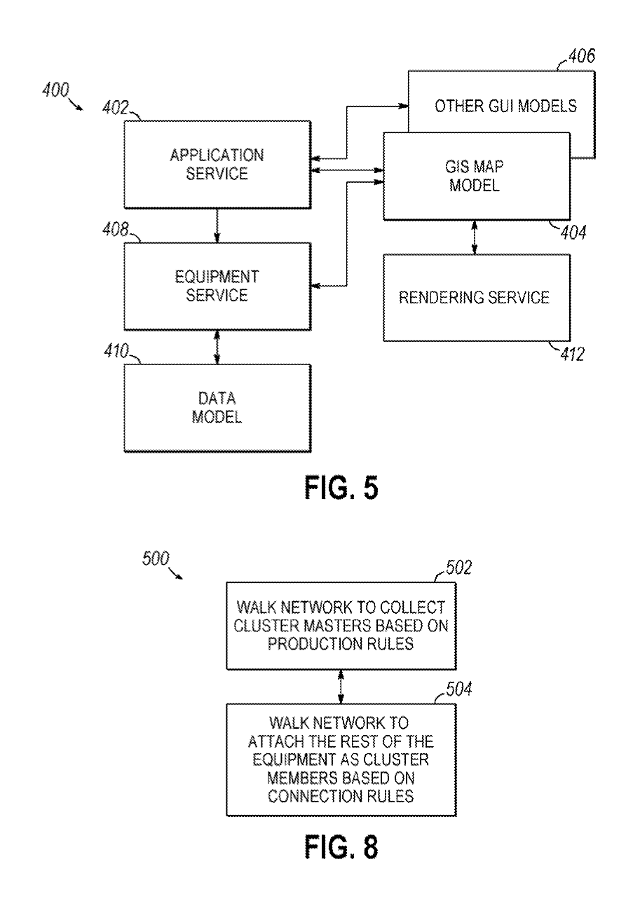

FIG. 5 illustrates one implementation of a production system application 400 within which the herein-described techniques may be implemented. An application service module 402 handles events that are broadcast to various Graphical User Interface (GUI) components in the application, e.g., a GIS map model module 404 with a GIS map, and one or more other GUI model modules 406 (e.g., providing a hierarchical tree view of the production system of objects in the application, among other controls and displays) that are kept in synchronization with one another (e.g., an object list, selected objects, etc.). When a user selects to view a network of objects via the GIS map model module 404, or this component has been informed by the application service module 402 that the network has been changed from one of the other application GUI modules 406, the GIS map model module 404 accesses an equipment service module 408. This module may retrieve a data model representing the current production system of objects and connections, along with the logical and physical location information for each object, from a data model module 410.

Equipment service module 408 may then exercise the herein-described clustering logic if GIS map model module 404 has requested this view, and return the network of objects, connections, and locations to the GIS map model module 404. This GIS map model module may render the network of objects using a rendering service module 412, which defines how to render the objects, including a cluster object image. Each of the herein-described application modules—the application service module 402 that notifies GUI components such things as what objects are in the network and what objects are currently selected, the rendering service module 412 that draws the network of connected objects on the GIS map, the data model module 410 that persists the current state of the network objects, along with their logical and physical location (some objects having logical and physical locations at the same location, some having different logical and physical locations)—may be unchanged by the introduction of a cluster object on the GIS map. For these canvases, the cluster object may simply be a list of multiple objects. If the cluster object is selected, for example, the application service module 402 may be notified that multiple objects are selected.

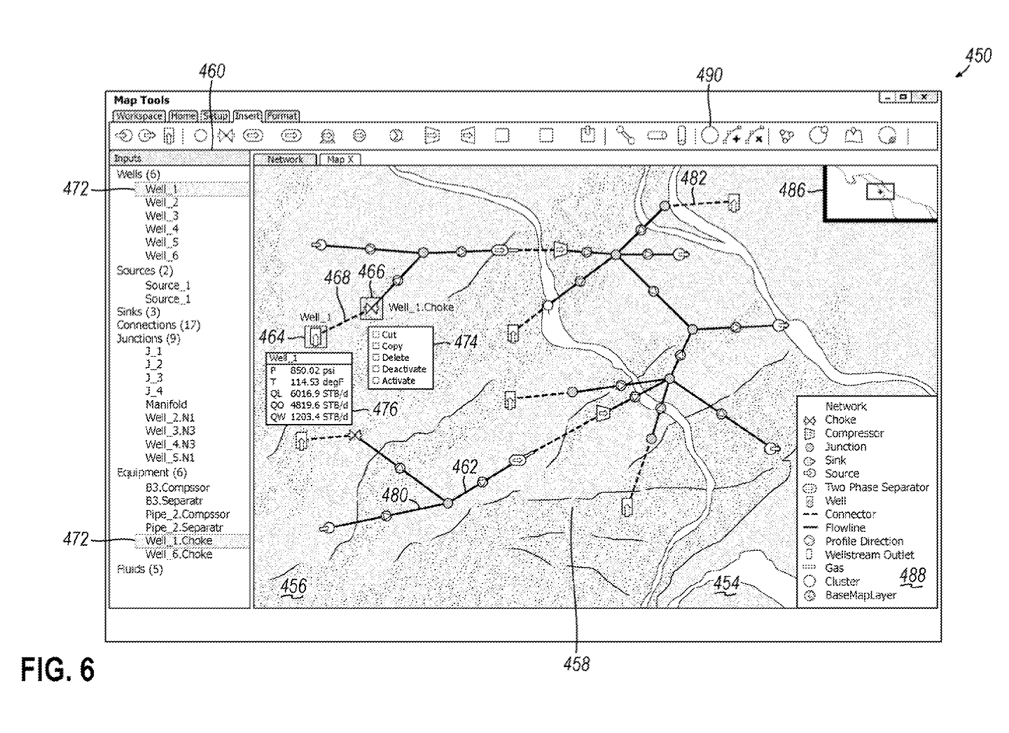

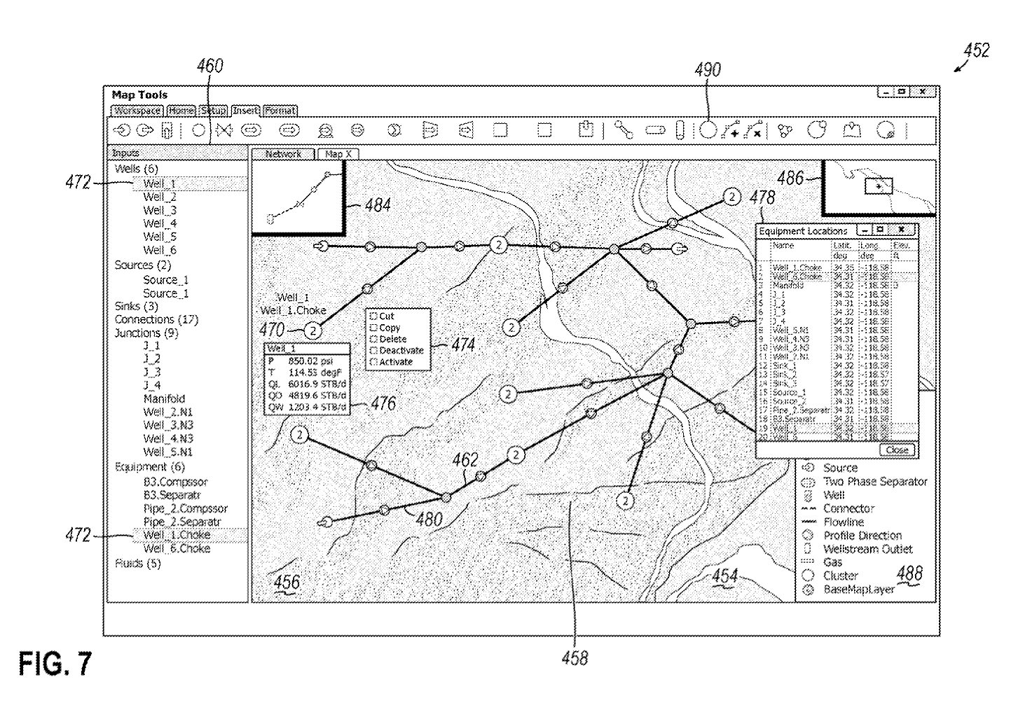

FIGS. 6 and 7, for example, respectively illustrate logical (FIG. 6) and physical (FIG. 7) layout views 450 and 452 of a GIS map 454 displayed in a GUI user interface component (e.g., a form, panel or window) 456 including a GIS-based interface. An oil and gas user may open the production system application and work in one or both of logical and physical views 450, 452, switching between them as desired.

For example, a user may build a skeleton network of equipment objects 458 on the GIS map window 456 while in a logical view 450 by inserting objects in any of a number of available GUI-based techniques—e.g., from a toolbar 460—and connecting them with flow line and connector objects 462. Equipment such as wells 464 (e.g., Well_1) and chokes 466 (e.g., Well_1_Choke) may be connected with connector lines 468, represented as dashed straight lines in logical view 450, to denote equipment at the same physical location, or with pipeline objects (flow lines or riser objects) that may follow an irregular path from one object to another.

A user may select an object such as Well_1 464 or multiple objects such as Well_1 464 and Well_1_Choke 466 to work on—here, mouse clicking on one object or pressing control key +mouse click on multiple objects. The objects may be shown selected with a highlight squares around them, as illustrated in FIG. 6.

As shown in FIG. 7, when the physical layout view 452 is selected, multiple objects at the same location or at closely proximate locations may be collapsed to a single “cluster” object, e.g., object 470 representing both Well_1 and Well_1_Choke. Note that associated user interface components such as tree panel 472 may represent a hierarchical tree view of the same network in the GIS map panel; both are synchronized such that equipment selection in one panel selects in the other—whether single or multiple selections. A single cluster object 470 representing multiple equipment objects in the physical GIS map panel may also be synchronized to the same but separate multiple equipment objects in tree panel 472.

A user may perform operations on multiple clustered objects in response to actions directed to a cluster object. For example, a user may edit equipment properties on individual equipment by bringing up a context menu 474 of commands on a single, selected equipment object, e.g., Well_1 464, by bringing up a context menu 474 on multiple selected equipment objects e.g., Well_1 464 and Well_1_Choke 466, whether separate objects or a cluster object, or by double-clicking on a non-cluster object or cluster object to bring up a more advanced editor of properties for the selected object or objects. Moving single objects, multiple objects, or single cluster objects representing multiple objects at the same physical location may be implemented similarly—a user selects one or more with a mouse, touch pad, touch screen or other pointing device, then moves the object or objects together.

Other user interface components that represent the same network of objects and respond to user selection may not be impacted but rather may be synchronized with the map—for example, a user interface panel such as tree panel 472 displaying a tree hierarchy of unconnected equipment object types (explained above), an annotation panel 476 (e.g., a grid view of automatically filtered simulation task results associated with a specifically selected object or selected set of objects, as illustrated in FIGS. 6-7, or other graph types, etc.)—or a modeless panel 478 (FIG. 7) showing object elevations and coordinate information with selections highlighted. In some embodiments, selecting an object or object cluster in one panel (e.g., GIS map panel 456) selects in the others (panels 472, 478) or vice versa. In addition, changing the physical location of any equipment in a cluster in one panel (e.g., panel 456 or panel 478) may change it in the other.

Auxiliary objects representing auxiliary components, e.g., nodal points, reports, gauges, etc., may also be incorporated into GIS map 454, e.g., via toolbar button 490, and when physically co-located with any additional auxiliary or physical components, may be clustered into cluster objects in physical layout view 452 in a similar manner to equipment objects representing physical components.

In addition, operations, such as but not exclusive to simple, common clipboard actions such as copy/cut/paste, object-specific actions such as show results associated with selection, or network options such as use GIS locations, may be directed to physically separate objects, clustered objects, or the network (e.g., using context menu 474).

Object information, such as but not exclusive to at-object or at-object-cluster labels, annotations 476—e.g., data results from simulation tasks run and displayed as different graph types, grids, etc.—may be shown in the same way over objects, whether they are shown logically or physically.

Additional enhancements may also be provided to differentiate working with the GIS map with all objects shown (e.g., in logical view 450 of FIG. 6) or all objects shown at the associated physical location (e.g., in physical view 452 of FIG. 7 with clustered objects). These include but are not exclusive to:

A distinct object representation on the GIS map for clustered objects (multiple objects at the same location)—e.g., as shown by cluster objects 470 in FIG. 7, a circle with the number of objects in the cluster. The label for the cluster may list some or all of the object labels in the cluster when it is shown (e.g., as shown in FIG. 7 with object labels corresponding to both Well_1 and Well_1_Choke). Two additional connector objects, referred to herein as flow line and riser objects, may be handled as physical objects in their own right, with properties such as length. A user may use such objects to connect two other networks objects, such as a well and a compressor, together. In this example, these may be displayed on the GIS map panel 456 in the cluster (physical) or un-clustered (logical) network views as solid, differently colored, styled, multi-angled lines, e.g., line 480.

A connector object, referred to herein as a connector, may be used by a user to identify that an object is connected to another object at the same location. In this example, a connector object may be displayed on the GIS map panel 456 in the logical or un-clustered network view as a differentiating dotted line style, e.g., line 482.

A panel 484 may be shown or hidden by the user on the GIS map panel 456 for physical (cluster) layout view 452 (FIG. 7) and that shows to the user a preview representation of the logical layout of each object in the selected cluster object. This same panel may be utilized in physical (cluster) layout view when the use hovers over an object when connecting one object to another object in a cluster (or vice versa). This panel may be used to supplement other GIS panels—e.g., map overview panel 486 showing a user's current focused view relative to the whole map, a legend panel 488 showing keys to the meaning of map symbols on the map (e.g., the production network object symbols, including the cluster object).

In addition, as shown in FIG. 8, embodiments consistent with the invention may also utilize an underlying architecture and logic, represented by flowchart 500, that incorporates the steps and rules for identifying objects in a cluster and putting them at their associated physical location on the map. Such logic may be configured to, in block 502, walk the complete network (i.e., equipment objects, auxiliary objects and connector objects) to collect cluster masters according to a set of production system rules (e.g., where wells, sinks, sources, and junctions are weighted as primary cluster masters).

Then, in block 504, the complete network may be walked a second time to attach the rest of the components as cluster members according to an algorithm with connection rules, which uses information about the type of link between equipment objects (e.g., a connector or flow line/riser). If such objects are not cluster members, then these objects may become clusters too. During this second pass, some clusters may be collapsed into other clusters according to the connection rules and their members joined into these clusters. These cluster objects may subsequently be shown in the clustered (physical layout) view as a new selectable object representing clustered objects at the same physical location on the GIS map.

Implementation of the aforementioned functionality in a GIS map user interface would be well within the abilities of one of ordinary skill in the art having the benefit of the instant disclosure. In addition, while particular embodiments have been described, it is not intended that the invention be limited thereto, as it is intended that the invention be as broad in scope as the art will allow and that the specification be read likewise. It will therefore be appreciated by those skilled in the art that yet other modifications could be made without deviating from its spirit and scope as claimed.

In this description, the term or' is used inclusively to indicate A or B or both unless stated otherwise, The term may is used to express possibility, such as possible embodiments. In the claims that follow, only those claims that state “means for” are to be interpreted as means-plus-function claims.

What is claimed is:

1. A method of visualizing an oil & gas production network, the method comprising:
using at least one processor, causing a display representation of a production network to be displayed in a Geological Information System (GIS) map user interface, the display representation including a physical view of a plurality of equipment objects representing physical components in the production network and positioned relative to a map according to physical locations of the physical components represented thereby, wherein the display representation further includes a cluster object associated with a plurality of co-located physical components in the production network and positioned relative to the map according to a physical location associated with the plurality of co-located physical components; and
expanding the cluster object in place in the display representation by displaying a logical view of a plurality of clustered equipment objects representing the plurality of co-located physical components, wherein the logical view displays at least one clustered equipment object offset in the map from at least one other clustered equipment object and represents at least one physical interconnection between the plurality of co-located physical components.

2. The method of claim 1, wherein expanding the cluster object includes expanding each cluster object displayed in the display representation when switching from a physical layout view to a logical layout view.

3. The method of claim 1, wherein expanding the cluster object is performed without expanding at least one other cluster object displayed in the display representation.

4. The method of claim 1, further comprising synchronizing the GIS map user interface with a second user interface such that selection of an object on one of the GIS map user interface and the second user interface causes selection of an object on the other of the GIS map user interface and the second user interface.

5. The method of claim 4, wherein synchronizing the GIS map user interface with the second user interface includes selecting a plurality of objects associated with the plurality of co-located physical components in the second user interface in response to selection of the cluster object.

6. The method of claim 1, further comprising performing operations associated with each of the plurality of co-located physical components in response to performing an action directed to the cluster object.

7. The method of claim 1, wherein a display representation of the cluster object includes a numerical indicator of a number of co-located physical components.

8. The method of claim 1, wherein a display representation of the cluster object includes a list of identifiers for the co-located physical components.

9. The method of claim 1, wherein the logical view includes a connector object representing the physical interconnection.

10. The method of it 1, further comprising displaying a preview of the logical view in the physical view.

11. The method of claim 1, further comprising walking the production network to collect cluster masters based on at least one production system rule.

12. The method o claim 11, further comprising walking the production network a second time to attach cluster members to clusters based on at least one connection rule.

13. The method of claim 1, wherein the cluster object is further associated with at least one auxiliary component that is physically co-located with the plurality of co-located physical components in the production network, and wherein expanding the cluster object in place in the display representation includes displaying an auxiliary object associated with the auxiliary component in the logical view.

14. An apparatus, comprising:
at least one processor; and
program code configured upon execution by the at least one processor to visualize an oil & gas production network by:
causing a display representation of a production network to be displayed in a Geological Information System (GIS) map user interface, the display representation including a physical view of a plurality of equipment objects representing physical components in the production network and positioned relative to a map according to physical locations of the physical components represented thereby, wherein the display representation further includes a cluster object associated with a plurality of co-located physical components in the production network and positioned relative to the map according to a physical location associated with the plurality of co-located physical components; and
expanding the cluster object in place in the display representation by displaying a logical view of a plurality of clustered equipment objects representing the plurality of co-located physical components, wherein the logical view displays at least one clustered equipment object offset in the map from at least one other clustered equipment object and represents at least one physical interconnection between the plurality of co-located physical components.

15. The apparatus of claim 14, wherein the program code is configured to expand the cluster object by expanding each cluster object displayed in the display representation when switching from a physical layout view to a logical layout view.

16. The apparatus of claim 14, wherein the program code is further configured to synchronize the GIS map user interface with a second user interface such that selection of an object on one of the GIS map user interface and the second user interface causes selection of an object on the other of the GIS map user interface and the second user interface, and wherein the program code is configured to synchronize the GIS map user interface with the second user interface by selecting a plurality of objects associated with the plurality of co-located physical components in the second user interface in response to selection of the cluster object.

17. The apparatus of claim 14, wherein the program code is further configured to perform operations associated with each of the plurality of co-located physical components in response to performing an action directed to the cluster object.

18. The apparatus of claim 14, wherein a display representation of the cluster object includes a numerical indicator of a number of co-located physical components or a list of identifiers for the co-located physical components, and wherein the logical view includes a connector object representing the physical interconnection.

19. The apparatus of claim 14, wherein the program code is further configured to walk the production network a first time to collect cluster masters based on at least one production system rule, and walk the production network a second time to attach cluster members to clusters based on at least one connection rule,

20. A program product, comprising:
a computer readable medium; and program code configured upon execution by at least one processor to visualize an oil & gas production network by:
causing a display representation of a production network to be displayed in a Geological Information System (GIS) map user interface, the display representation including a physical view of a plurality of equipment objects representing physical components in the production network and positioned relative to a map according to physical locations of the physical components represented thereby, wherein the display representation further includes a cluster object associated with a plurality of co-located physical components in the production network and positioned relative to the map according to a physical location associated with the plurality of co-located physical components: and
expanding the cluster object in place in the display representation by displaying a logical view of a plurality of clustered equipment objects representing the plurality of co-located physical components, wherein the logical view displays at least one clustered equipment object offset in the map from at least one other clustered equipment object and represents at least one physical interconnection between the plurality of co-located physical components
